(19) United States
(12) Patent Application Publication
(10) Pub. No.: US 2013/0004306 A1
(43) Pub. Date: Jan. 3, 2013

(54) CHORDAL MOUNTING ARRANGEMENT FOR LOW-DUCTILITY TURBINE SHROUD

(75) Inventors: Joseph Charles Albers, Fort Wright, KY (US); Mark Willard Marusko, Springboro, OH (US)

(73) Assignee: GENERAL ELECTRIC COMPANY, Schenectady, NY (US)

(21) Appl. No.: 13/173,897

(22) Filed: Jun. 30, 2011

(51) Int. Cl. F02C 7/28; F01D 25/24; F02C 7/06

(52) U.S. Cl. 415/200; 415/182.1

(57) ABSTRACT

A shroud apparatus for a gas turbine engine includes: a shroud segment comprising low-ductility material and having a cross-sectional shape defined by opposed forward and aft walls, and opposed inner and outer walls, the walls extending between opposed first and second end faces, wherein the inner wall defines an arcuate inner flowpath surface, wherein the shroud segment includes: a radially-inward facing chordal forward mounting surface; and a radially-inward facing chordal aft mounting surface; and an annular case surrounding the shroud segment, the case including: a radially-outward facing chordal forward bearing surface which engages the forward mounting surfaces; and a radially-outward facing chordal aft bearing surface which engages the aft mounting surface of the shroud segment.

### BACKGROUND OF THE INVENTION

This invention relates generally to gas turbine engines, and more particularly to apparatus and methods for mounting shrouds made of a low-ductility material in the turbine sections of such engines.

A typical gas turbine engine includes a turbomachinery core having a high pressure compressor, a combustor, and a high pressure turbine in serial flow relationship. The core is operable in a known manner to generate a primary gas flow. The high pressure turbine (also referred to as a gas generator turbine) includes one or more rotors which extract energy from the primary gas flow. Each rotor comprises an annular array of blades or buckets carried by a rotating disk. The flowpath through the rotor is defined in part by a shroud, which is a stationary structure which circumscribes the tips of the blades or buckets. These components operate in an extremely high temperature environment, and must be cooled by air flow to ensure adequate service life. Typically, the air used for cooling is extracted (bled) from the compressor. Bleed air usage negatively impacts specific fuel consumption (“SFC”) and should generally be minimized.

It has been proposed to replace metallic shroud structures with materials having better high-temperature capabilities, such as ceramic matrix composites (CMCs). These materials have unique mechanical properties that must be considered during design and application of an article such as a shroud segment. For example, CMC materials have relatively low tensile ductility or low strain to failure when compared with metallic materials. Also, CMCs have a coefficient of thermal expansion (“CTE”) in the range of about 1.5-5 microinch/inch/degree F., significantly different from commercial metal alloys used as supports for metallic shrouds. Such metal alloys typically have a CTE in the range of about 7-10 microinch/inch/degree F.

CMC shrouds may be segmented to lower stresses from thermal growth and allow the engine's clearance control system to work effectively. One known type of segmented CMC shroud incorporates a hollow “box” design. CMC shrouds must be positively positioned in order for the shroud to effectively perform. Some CMC shrouds have been designed with the shroud component attached to an engine case using a metallic hanger or load spreader. The hanger or load spreader uses radially-aligned bolts to position and retain the shroud. While effective for mounting and positioning, the hanger or load spreader presents design challenges such as bolt bending, creep, air leaks, wear, and friction related problems.

Accordingly, there is a need for an apparatus for mounting CMC and other low-ductility turbine structures without using bolted joints.

### BRIEF DESCRIPTION OF THE INVENTION

This need is addressed by the present invention, which provides a shroud which is positioned and retained to a surrounding structure by chordal surfaces.

According to one aspect of the invention, a shroud apparatus for a gas turbine engine includes: a shroud segment comprising low-ductility material and having a cross-sectional shape defined by opposed forward and aft walls, and opposed inner and outer walls, the walls extending between opposed first and second end faces, wherein the inner wall defines an arcuate inner flowpath surface, wherein the shroud segment includes: a radially-inward facing chordal forward mounting surface; and a radially-inward facing chordal aft mounting surface; and an annular case surrounding the shroud segment, the case including: a radially-outward facing chordal forward bearing surface which engages the forward mounting surfaces; and a radially-outward facing chordal aft bearing surface which engages the aft mounting surface of the shroud segment.

### BRIEF DESCRIPTION OF THE DRAWINGS

The invention may be best understood by reference to the following description taken in conjunction with the accompanying drawing figures in which:

FIG. 1 is a schematic cross-sectional view of a portion of a turbine section of a gas turbine engine, incorporating a shroud mounting apparatus constructed in accordance with an aspect of the present invention;

FIG. 2 is a front elevation view of a shroud segment of the turbine section shown in FIG. 1;

FIG. 3 is an end view of the shroud segment of FIG. 2;

FIG. 4 is a schematic front elevation view showing several shroud segments assembled together;

FIG. 5 is an aft elevational view of a forward retainer seen in FIG. 1;

FIG. 6 is a schematic cross-sectional view of a portion of a turbine section of a gas turbine engine, incorporating an alternative shroud mounting apparatus constructed in accordance with an aspect of the present invention;

FIG. 7 is a schematic cross-sectional view of a portion of a turbine section of a gas turbine engine, incorporating another alternative shroud mounting apparatus constructed in accordance with an aspect of the present invention; and

FIG. 8 is a schematic cross-sectional view of a portion of a turbine section of a gas turbine engine, incorporating yet another alternative shroud mounting apparatus constructed in accordance with an aspect of the present invention.

### DETAILED DESCRIPTION OF THE INVENTION

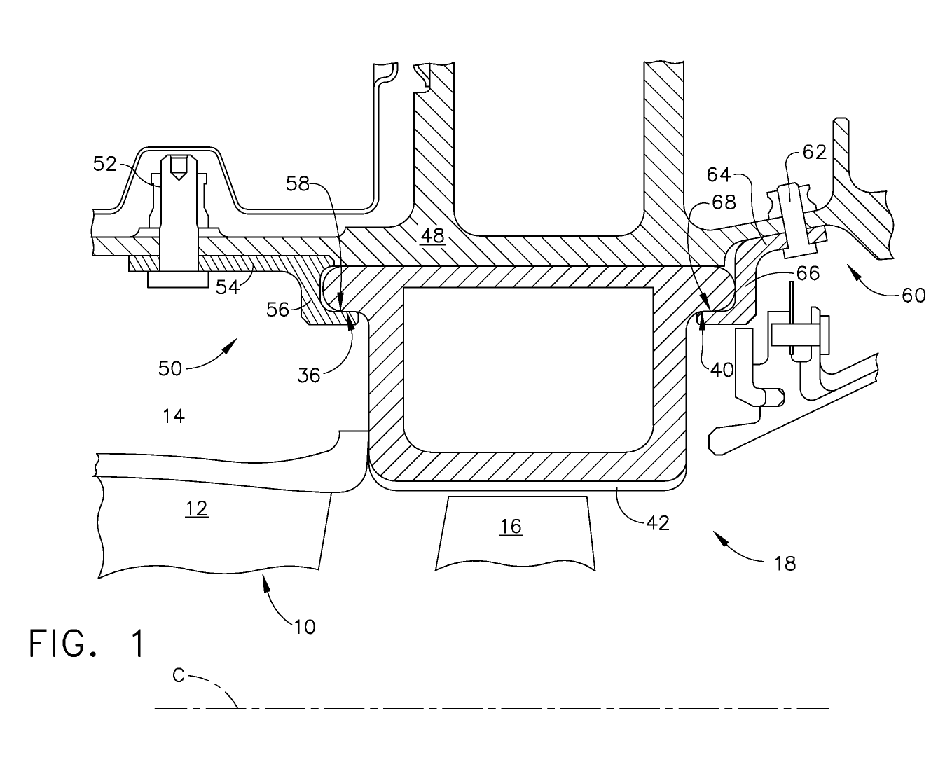

Referring to the drawings wherein identical reference numerals denote the same elements throughout the various views, FIG. 1 depicts a small portion of a high pressure turbine (“HPT”), which is part of a gas turbine engine of a known type. The function of the high pressure turbine is to extract energy from high-temperature, pressurized combustion gases from an upstream combustor (not shown) and to convert the energy to mechanical work, in a known manner. The high pressure turbine drives an upstream compressor (not shown) through a shaft so as to supply pressurized air to the combustor.

The principles described herein are equally applicable to turbofan, turbojet and turboshaft engines, as well as turbine engines used for other vehicles or in stationary applications. Furthermore, while a turbine nozzle is used as an example, the principles of the present invention are applicable to any low-ductility flowpath component which is at least partially exposed to a primary combustion gas flowpath of a gas turbine engine.

The HPT includes a stationary nozzle 10. It may be of unitary or built-up construction and includes a plurality of airfoil-shaped stationary turbine vanes 12 circumscribed by an annular outer band 14. The outer band 14 defines the outer radial boundary of the gas flow through the turbine nozzle 10. It may be a continuous annular element or it may be segmented.

Downstream of the nozzle 10, there is a rotor disk (not shown) that rotates about a centerline axis of the engine and carries an array of airfoil-shaped turbine blades 16. A shroud comprising a plurality of arcuate shroud segments 18 is arranged so as to encircle and closely surround the turbine blades 16 and thereby define the outer radial flowpath boundary for the hot gas stream flowing through the turbine blades 16.

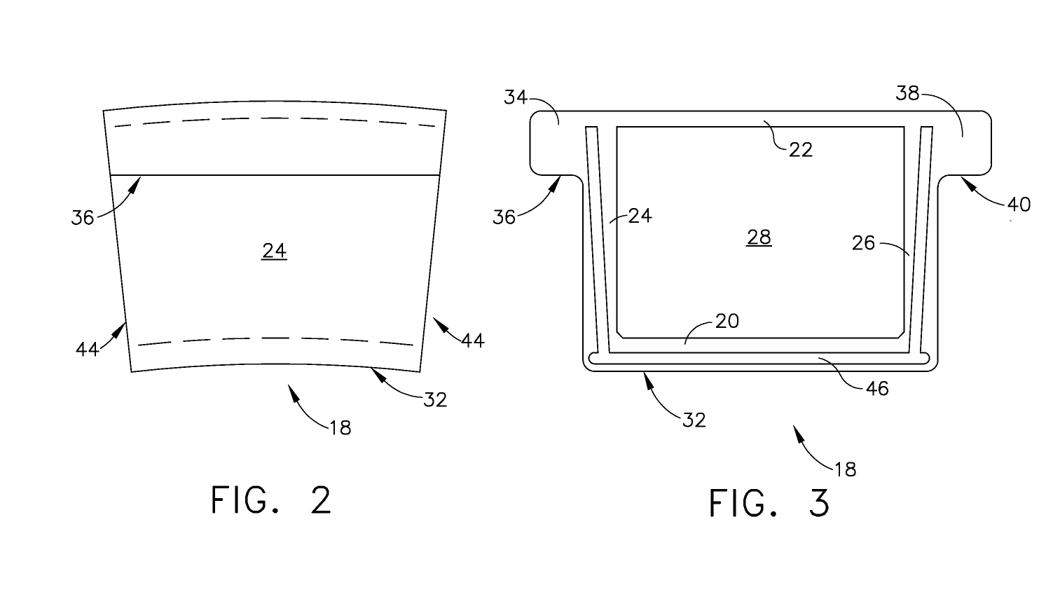

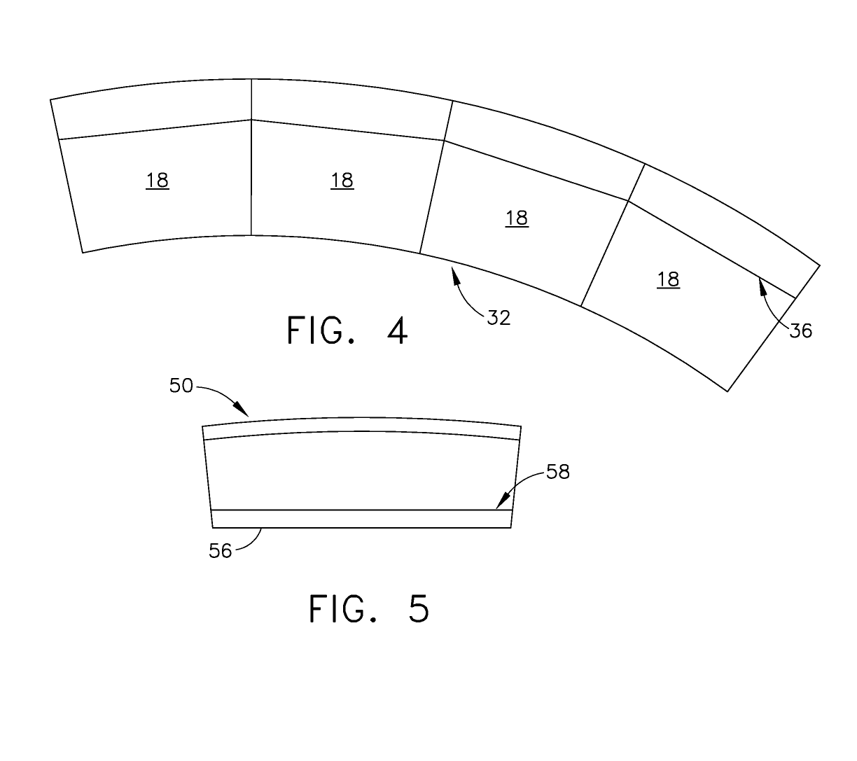

As seen in FIGS. 2 and 3, each shroud segment 18 has a generally rectangular or “box”-shaped hollow cross-sectional shape defined by opposed inner and outer walls 20 and 22, and forward and aft walls 24 and 26. Radiused, sharp, or square-edged transitions may be used at the intersections of the walls. A shroud cavity 28 is defined within the walls 20, 22, 24, and 26. The inner wall 20 defines an arcuate radially inner flowpath surface 32. The outer wall 22 extends axially forward past the forward wall 24 to define a forward flange 34 with a radially-inward-facing forward mounting surface 36 and it also extends axially aft past the aft wall 26 to define an aft flange 38 with a radially-inward-facing aft mounting surface 40. The flowpath surface 32 follows a circular arc in elevation view (e.g. forward looking aft or vice-versa). However, the mounting surfaces 36 and 40 follow a straight line corresponding to a chord of a circle. FIG. 4 shows several shroud segments 18 assembled side-by-side which illustrates this aspect of the shroud segments 18 in more detail. When assembled into a complete closed annular array, the mounting surfaces 36 and 40 each define a closed polygonal shape in elevation view, with the number of sides of the polygon being equal to the number of shroud segments 18. As used herein, the term “chordal surface” refers interchangeably to either the complete polygonal shape or to the surfaces which make up its individual sides.

The shroud segments 18 are constructed from a ceramic matrix composite (CMC) material of a known type. Generally, commercially available CMC materials include a ceramic type fiber for example SiC, forms of which are coated with a compliant material such as Boron Nitride (BN). The fibers are carried in a ceramic type matrix, one form of which is Silicon Carbide (SiC). Typically, CMC type materials have a room temperature tensile ductility of no greater than about 1%, herein used to define and mean a low tensile ductility material. Generally CMC type materials have a room temperature tensile ductility in the range of about 0.4 to about 0.7%. This is compared with metals having a room temperature tensile ductility of at least about 5%, for example in the range of about 5 to about 15%. The shroud segments 18 could also be constructed from other low-ductility, high-temperature-capable materials.

The flowpath surface 32 of the shroud segment 18 may incorporate a layer of environmental barrier coating (“EBC”), an abradable material, and/or a rub-tolerant material 42 of a known type suitable for use with CMC materials. This layer is sometimes referred to as a “rub coat” and is depicted schematically in FIG. 1. In the illustrated example, the rub coat 42 is about 0.51 mm (0.020 in.) to about 0.76 mm (0.030 in.) thick.

The shroud segments 18 include opposed end faces 44 (also commonly referred to as “slash” faces). The end faces 44 may lie in a plane parallel to the centerline axis of the engine, referred to as a “radial plane”, or they may be slightly offset from the radial plane, or they may be oriented so to they are at an acute angle to such a radial plane. When assembled into a complete ring, end gaps are present between the end faces 44 of adjacent shroud segments 18. One or more seals (not shown) may be provided at the end faces 44. Similar seals are generally known as “spline seals” and take the form of thin strips of metal or other suitable material which are inserted in slots 46 in the end faces 44. The spline seals span the gaps between shroud segments 18.

The shroud segments 18 are mounted to a stationary metallic engine structure, shown in FIG. 1. In this example the stationary structure is part of a turbine case 48. A forward retainer 50 is secured to the turbine case 48, for example using the illustrated bolt 52. The forward retainer 50 is a metallic annular structure and may be continuous or segmented. It is depicted as segmented in this example. The forward retainer 50 includes a body 54 with an L-shaped hook 56 extending radially inward. The hook 56 defines a radially-outward facing forward bearing surface 58 which bears against the forward mounting surface 36 of the shroud segment 18. The forward bearing surface 58 defines a closed polygonal shape in elevation view (e.g. forward looking aft or vice-versa), with the number of sides of the polygon being equal to the number of shroud segments 18. The forward bearing surface 58 is therefore a chordal surface as described above, whether considering individual sides of the shape, or the shape as a whole. In the illustrated example, each side of the forward bearing surface 58 is substantially the same chordwise length as the forward mounting surface 36 of a single shroud segment 18, and is disposed at substantially the same radial distance from the longitudinal centerline “C” of the engine as a corresponding side of the forward mounting surface 36. As best seen in FIG. 5, the forward retainer 50 may be segmented such that only a portion of the complete polygonal forward bearing surface 58 is included on each segment.

An aft retainer 60 is secured to the turbine case 48, for example using the illustrated bolt 62. The aft retainer 60 is a metallic annular structure and may be continuous or segmented. The aft retainer 60 includes a body 64 with an L-shaped hook 66 extending radially inward. The hook 64 defines a radially-outward facing aft bearing surface 68 which bears against the aft mounting surface 40 of the shroud segment 18. The aft bearing surface 68 defines a closed polygonal shape in elevation view, with the number of sides of the polygon being equal to the number of shroud segments 18. In the illustrated example, each side of the aft bearing surface 68 is substantially the same chordwise length as a side of the aft mounting surface 40 of the shroud segment 18, and is disposed at substantially the same radial distance from the longitudinal centerline “C” of the engine. The aft bearing surface 60 is a chordal surface as described above.

In operation, all of the components, including the turbine case 48, retainers 50 and 60, and the shroud segments 18 will tend to expand and contract as temperatures rise and fall. Unlike a conventional arcuate or circular mounting interface, the chordal interface described above, consisting of the chordal shroud segment mounting surfaces contacting the chordal forward and aft bearing surfaces, allows sealing to take place between the two flat surfaces. Appropriate gaps or slots may be provided between the bearing surfaces 36, 40 and the mounting surfaces 58, 68 to permit cooling air to pass around or into the shroud segments 18. While the dimensions of these surfaces may change with temperature changes during operation, the dimensional changes will be in the nature of linear expansion or contraction, as opposed to the changing of the radius of curvatures of curved surfaces, which can cause large gaps to open between two components. As compared to the prior art, this aspect of the present invention reduces the dependence on machine matched faces or matching of thermal growth differences. This configuration also allows better control over the flow of cooling air which can be defined and regulated with leakage channels or known areas with less reliance on inadvertent leakage due to inefficient sealing.

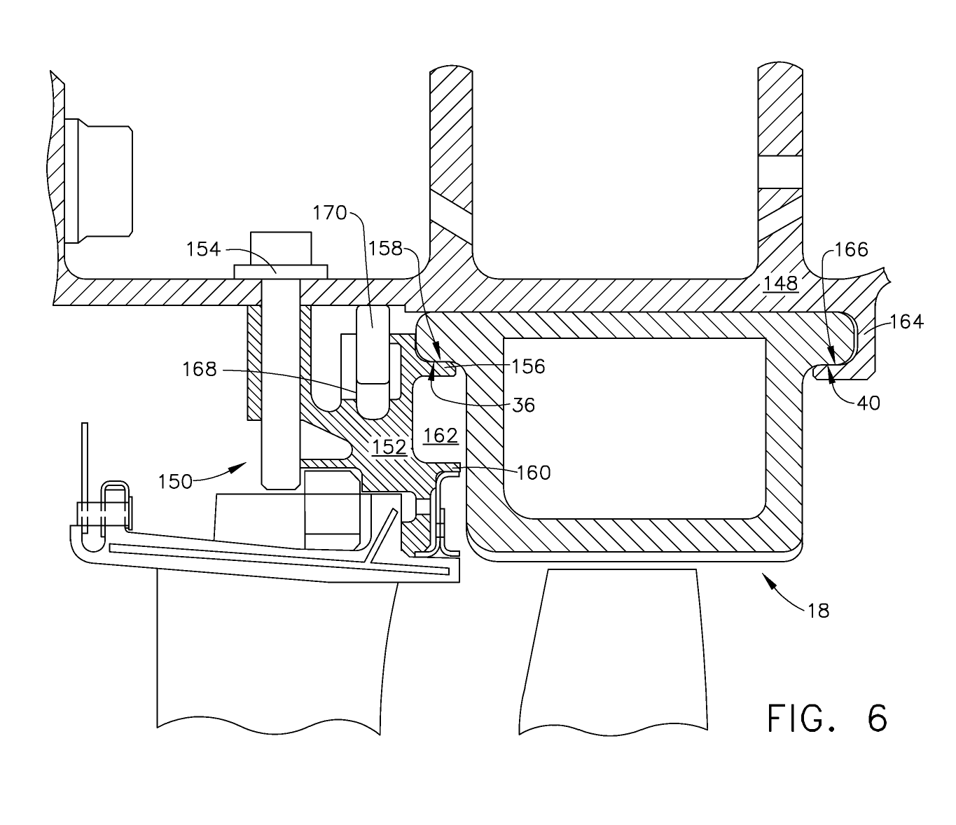

FIG. 6 illustrates an alternative configuration for mounting shroud segments 18 to a stationary metallic engine structure, such as a turbine case 148. The turbine case 148 includes an aft hook 164. It is an annular component with an L-shaped cross-section. The aft hook 164 may be formed integrally with the turbine case 148, or as a separate component which is mechanically tied into the turbine case 148. The aft hook 164 defines a radially-outward facing aft bearing surface 166 which bears against the aft mounting surface 40 of the shroud segment 18. The aft bearing surface 166 is a chordal surface as described above.

An annular metallic nozzle support 150 is positioned axially forward of the shroud segment 18. It includes a body 152. The nozzle support 150 is rigidly coupled to the turbine case 148, for example using mechanical fasteners 154. A flange 156 extends axially aft from the body 152. The flange 156 defines a radially-outward facing forward bearing surface 158 which bears against the forward mounting surface 36 of the shroud segment 18. The forward bearing surface 158 is a chordal surface as described above.

A seal tooth 160 extends aft from the rear of the body 152. Any number of seal teeth may be used. In cooperation with the aft surface of the body 152 and the flange 156, the seal tooth 160 defines a seal pocket 162. An annular, outboard-facing seal slot 168 is also formed in the body 152.

A seal in the form of a piston ring 170 is disposed in seal slot 168 and seals against the inner surface of the turbine case 148. The piston ring 170 is of a known type which provides a continuous (or nearly continuous) circumferential seal. It is split at one circumferential location, and is configured to provide a radially outward spring tension. The piston ring 170 may include known features which serve to reduce leakage between the ring ends, such as overlapping end tabs. Other known variations of the ring structure, such as different types of end arrangements, multi-part or “gapless” rings, or tandem rings (not shown) could also be used.

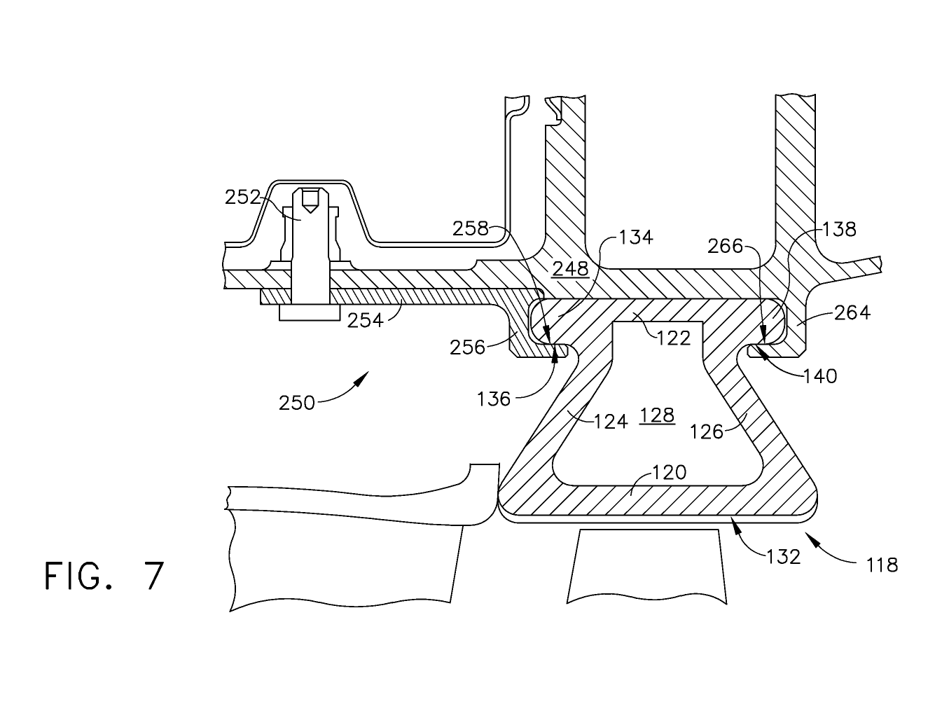

FIG. 7 shows an alternative shroud segment 118 mounted to a turbine case 248. The shroud segments 118 are constructed from a ceramic matrix composite (CMC) material or other low-ductility material as described above, and are generally similar in construction to the segments 18 described above except for their cross-sectional shape. Each shroud segment 118 has a shape defined by opposed inner and outer walls 120 and 122, and forward and aft walls 124 and 126. A shroud cavity 128 is defined within the walls 120, 122, 124, and 126. The outer wall 122 has a substantially shorter axial length than the inner wall 120, and each of the forward and aft walls 124 and 126 extend away from the inner wall 120 at an acute angle. Collectively, the walls 120, 122, 124, and 126 define a generally trapezoidal cross-sectional shape. The trapezoidal cross-sectional shape reduces the amount of axial space required to mount the shroud segments 118 as compared to the shroud segments 18 described above. The inner wall 120 defines an arcuate radially inner flowpath surface 132. The outer wall 122 extends axially forward past the forward wall 124 to define a forward flange 134 with a forward mounting surface 136, and it also extends axially aft past the aft wall 126 to define an aft flange 138 with an aft mounting surface 140. The flowpath surface 132 follows a circular arc in elevation view (e.g. forward looking aft or vice-versa). The mounting surfaces 136 and 140 are chordal surfaces as defined above. The shroud segments 118 may include slots for spline seals as described above (not shown).

A forward retainer 250 is secured to the turbine case 248, for example using the illustrated bolt 252. The forward retainer 250 is a metallic annular structure and may be continuous or segmented. The forward retainer 250 includes a body 254 with an L-shaped hook 256 extending radially inward. The hook 256 defines a radially-outward facing forward bearing surface 258 which bears against the forward mounting surface 136 of the shroud segment 118. The forward bearing surface 258 is a chordal surface as described above.

The turbine case 248 includes an aft hook 264. It is an annular component with an L-shaped cross-section. The aft hook 264 may be formed integrally with the turbine case 248, or as a separate component which is mechanically tied into the turbine case 248. The aft hook 264 defines a radially-outward facing aft bearing surface 266 which bears against the aft mounting surface 140 of the shroud segment 118. The aft bearing surface 266 is a chordal surface as described above.

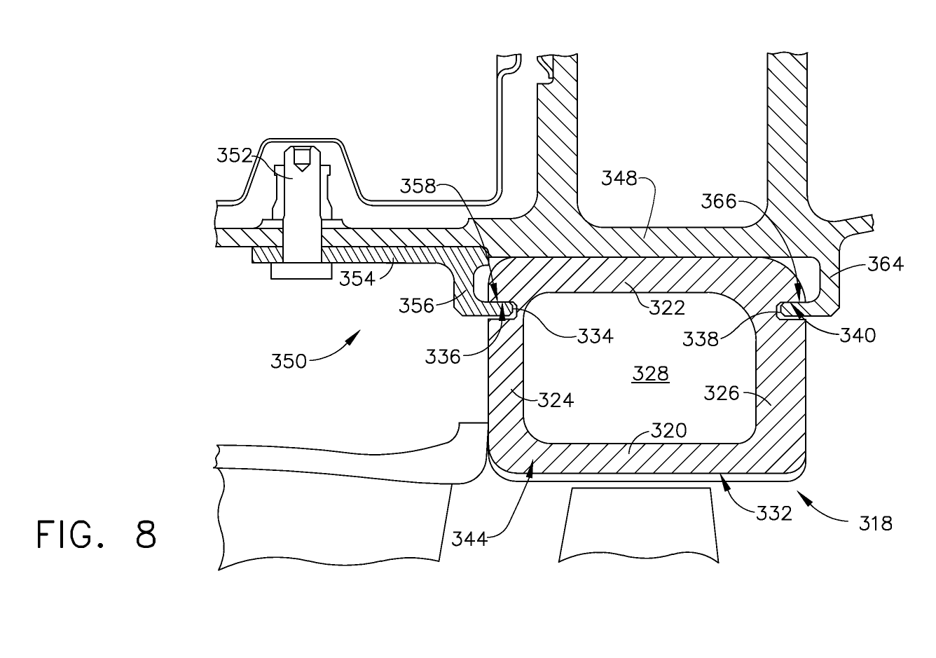

FIG. 8 shows an alternative shroud segment 318. The shroud segments 318 are constructed from a ceramic matrix composite (CMC) material or other low-ductility material as described above, and are generally similar in construction to the segments 18 described above except for their cross-sectional shape. Each shroud segment 318 has a generally rectangular cross-sectional shape defined by opposed inner and outer walls 320 and 322, and forward and aft walls 324 and 326. A shroud cavity 328 is defined within the walls 320, 322, 324, and 326. The inner wall 320 defines an arcuate radially inner flowpath surface 332. A notch 334 is formed in the forward wall 324, defining a radially-inward-facing forward mounting surface 336. A notch 338 is formed in the aft wall 326, defining a radially-inward-facing aft mounting surface 340. The flowpath surface 332 follows a circular arc in elevation view. The mounting surfaces 334 and 340 are chordal surfaces as described above. The end faces 344 of the shroud segments 318 may include slots for spline seals as described above (not shown).

A forward retainer 350 is secured to the turbine case 348, for example using the illustrated bolt 352. The forward retainer 350 is a metallic annular structure and may be continuous or segmented. The forward retainer 350 includes a body 354 with an L-shaped hook 356 extending radially inward. The hook 356 defines a radially-outward facing forward bearing surface 358 which bears against the forward mounting surface 336 of the shroud segment 318. The forward bearing surface 358 is a chordal surface as described above.

The turbine case 348 includes an aft hook 364. It is an annular component with an L-shaped cross-section. The aft hook 364 may be formed integrally with the turbine case 348, or as a separate component which is mechanically tied into the turbine case 348. The aft hook 364 defines a radially-outward facing aft bearing surface 366 which bears against the aft mounting surface 340 of the shroud segment 318. The aft bearing surface 366 is a chordal surface as described above.

The shroud mounting apparatus described above is effective to mount a low-ductility shroud in a turbine engine. It is not dependent on friction forces and has a simply air sealing arrangement. The design is simple and has a small part count. In this configuration the shroud is pressure loaded against chordal surfaces that act to position and retain the shroud as well as provide an additional sealing surface. The surfaces are chordal and not arched so that that the sealing can take place between two flat surfaces. This reduces the dependence on machine matched faces or thermal growth differences. This configuration also allows better control over the cooling air which can be defined and regulated with leakage channels or know areas with less reliance on inadvertent leakage due to inefficient sealing. Because there are no metal components inside the shroud, the radial height of the shroud can be minimized. Without the need for a hanger and the minimized radial height of the shroud, less room is needed between the blade tip and the turbine case allowing the turbine case to be moved in radially saving weight and cost.

The foregoing has described a turbine shroud mounting apparatus for a gas turbine engine. While specific embodiments of the present invention have been described, it will be apparent to those skilled in the art that various modifications thereto can be made without departing from the spirit and scope of the invention. Accordingly, the foregoing description of the preferred embodiment of the invention and the best mode for practicing the invention are provided for the purpose of illustration only and not for the purpose of limitation.

What is claimed is:

1. A shroud apparatus for a gas turbine engine, comprising:
a shroud segment comprising low-ductility material and having a cross-sectional shape defined by opposed forward and aft walls, and opposed inner and outer walls, the walls extending between opposed first and second end faces, wherein the inner wall defines an arcuate inner flowpath surface, wherein the shroud segment includes:
a radially-inward facing chordal forward mounting surface; and
a radially-inward facing chordal aft mounting surface; and
an annular case surrounding the shroud segment, the case including:
a radially-outward facing chordal forward bearing surface which engages the forward mounting surfaces; and
a radially-outward facing chordal aft bearing surface which engages the aft mounting surface of the shroud segment.

2. The apparatus of claim 1 wherein:
the forward wall includes a forward flange extending axially therefrom that defines the forward mounting surface; and
the aft wall includes an aft flange extending axially therefrom that defines the aft mounting surface.

3. The apparatus of claim 1 wherein at least a portion of each of the forward and aft walls is oriented at an acute angle to the outer wall, and wherein radially inner ends of the forward and aft walls are substantially closer together than radially outer ends thereof.

4. The apparatus of claim 1 wherein:
The forward wall includes a forward notch formed therein that defines the forward mounting surface; and
the aft wall includes an aft notch formed therein that defines the aft mounting surface.

5. The apparatus of claim 1 wherein the forward bearing surface is defined by a forward retainer which is attached to the case by one or more mechanical fasteners.

6. The apparatus of claim 5 wherein the forward retainer includes a body with an L-shaped hook extending radially inward therefrom, the hook defining the forward bearing surface.

7. The apparatus of claim 1 wherein the aft bearing surface is defined by an aft retainer which is attached to the case by one or more mechanical fasteners.

8. The apparatus of claim 7 wherein the aft retainer includes a body with an L-shaped hook extending radially inward therefrom, the hook defining the aft bearing surface.

9. The apparatus of claim 1 further including an annular nozzle support mounted to the case, the nozzle supporting including a body and a flange extending axially therefrom, the flange defining one of the bearing surfaces.

10. The apparatus of claim 9 wherein:
the nozzle support defines a radially-outward facing seal slot; and
a piston ring is disposed in the seal slot and extends radially outward so as to contact an inner surface of the case.

11. The apparatus of claim 10 wherein the nozzle support includes an annular axially-extending seal tooth which in cooperation with the flange defines an annular seal pocket adjacent the shroud segment.

12. The apparatus of claim 1 wherein the shroud segment comprises a ceramic matrix composite material.

13. The apparatus of claim 1 wherein an annular ring of shroud segments are arranged in an annular array within the casing, such that each of the mounting surfaces forms a closed polygonal shape.

14. The apparatus of claim 13 wherein each of the bearing surfaces forms a closed polygonal shape.
